(19) United States
(12) Patent Application Publication
(10) Pub. No.: US 2009/0075233 A1
(43) Pub. Date: Mar. 19, 2009

(54) SINGLE-USE HIGH-SPEED TURBINE DENTAL DRILL HANDPIECE

(75) Inventor: Fudong ZHANG, Beijing (CN)

Correspondence Address: MATTHIAS SCHOLL, 14781 MEMORIAL DRIVE, SUITE 1319, HOUSTON, TX, 77079, US

(73) Assignee: BEIJING NORTH POLE DENTAL HANDPIECES CO., LTD, Beijing (CN)

(21) Appl. No.: 12/208,490

(22) Filed: Sep. 11, 2008

Related U.S. Application Data
(63) Continuation of application No. PCT/CN2007/070111, filed on Jun. 14, 2007.

(30) Foreign Application Priority Data
Jul. 25, 2006 (CN) 200610200742.4

(51) Int. Cl. A61C 1/05

(52) U.S. Cl. 433/132

(57) ABSTRACT

A single use high-speed turbine dental drill handpiece, comprising: a head (1), a drilling needle (2), a front handle (3), a back handle (4), and a quick disconnect water and air adapter (13). The front end of the back handle (4) is connected with the front handle (3), the back end is connected with the quick disconnect water and air adapter (13). The back handle (4) has a solid monolithic structure with an inner through channel and is made of engineering plastics formed by single stage moulding. A water pipe passage (41) is set at the axle center of the front portion of the back handle (4), an air pipe passage (42) and an air return passage (43) are set at the eccentric position along the axial direction. An air pipe (5) and a water pipe (6) from the head (1) are inserted into the air pipe passage (42) and the water pipe passage (41), respectively, the clearance space is sealed by a sealing ring. The center of the rear end of the back handle (4) is protuberant to form a quick disconnect inner tube (45) having a center channel. The inner end of the center channel of the quick disconnect inner tube (45) is connected with a check valve (14). The check valve is inserted into the water pipe passage (41) at the front portion of the back handle (4). The outer wall of the valve body (144) of the check valve (14) contacting with the inner wall of the water pipe passage (41) is embedded with a sealing ring. The outlet of the air return passage (43) is located at a position between the outer wall of the back handle (4) and the quick disconnect inner tube (45).

### CROSS-REFERENCE TO RELATED APPLICATIONS

This is a National Stage Application of International Patent Application No. PCT/CN2007/070111, with an international filing date of Jun. 14, 2007, which is based on Chinese Patent Application No. 200610200742.4, filed Jul. 25, 2006. The contents of these specifications including any intervening amendments thereto are incorporated herein by reference.

### BACKGROUND OF THE INVENTION

1. Field of the Invention

The invention relates to the fields of medical instruments, and more particularly, to a hand-held dental instrument for drilling teeth.

2. Background of the Invention

High-speed turbine dental drill handpiece is an instrument for drilling teeth, and utilizes clean compressed air as power source to blow the turbine to rotate in a speed of around 300,000 revolutions per minute so as to drive the operation of the cutting tool (drilling needle). The high-speed turbine dental drill handpiece is inserted into the oral cavity of the patient during application and thus touches the parts inside of the oral cavity such as teeth, oral mucosa, blood, and so on. If one dental drill handpiece is applied to many patients and is not completely disinfected, it may result in the transmission of diseases. Especially, diseases such as hepatitis, AIDS, etc., can be transmitted through blood, saliva, and mucosa. More importantly, since the drilling needle of the high-speed turbine dental drill handpiece is driven by air turbine, when the pedal switch is switched off to stop supplying gas for the turbine, the turbine will still rotate for a certain time due to inertia. At this moment, the rotator system of the turbine becomes a turbine compressor. The extruded air will be discharged to the exhaust outlet of the original turbine chamber, while the openings at both ends of the turbine shaft center form negative pressure, so that a contaminated fluid formed during dental teeth drilling will be sucked into the turbine handpiece, and farther, into the handpiece adapter and connection pipelines. When using the handpiece again, the contaminated fluid will spray into the oral cavity of the next patient, resulting in contamination and disease transmission. Besides, due to the pressure change caused by the cut off of water supply, the cooling water system of the turbine handpiece will result in the occurrence of a fluid suckback phenomenon, and thereby, results in the same contamination as mentioned above. In order to solve the above-mentioned cross infection problem, methods such as high temperature steam disinfection, disinfection liquid immersion, are applied to disinfect the dental drill handpiece. Though these methods are effective to a certain extent, the handpiece often cannot be disinfected completely. The conventional high-speed and precise turbine dental drill handpiece has the advantages of high rotation speed and precise operation, but the manufacturing cost is high, and thus ir is not economic to discard the handpiece after a single use. In order to lower the manufacturing cost, the method of degrading the operation performance of the handpiece is often used, but the application requirement cannot be satisfied totally. Chinese Pat. No. CN2510028Y discloses a single use high-speed turbine dental drill handpiece, wherein the manufacturing cost is decreased largely, and the handpiece can be discarded after being used one time, so that iatrogenic cross infection is avoided. The dental drill handpiece comprises a head, a drilling needle, a front handle, a back handle, and a quick water and air disconnect adapter, as shown in FIG. 1. The shell of the back handle is a hollow thin wall tube with a positioning sleeve, a sealing cushion, a nut, and a quick disconnect adapter sleeve assembled therein. The water pipe 6 and air pipe 5 are sealed after passing through the positioning sleeve 7 and the sealing cushion 8 by pressing the disconnect adapter sleeve 11 onto the sealing cushion 8 via means of the nut 9. However, the structure of the back handle of the existing high-speed turbine dental drill handpiece is still complicated, and the assembly work is time consuming. Therefore, the structure needs to be improved further.

### SUMMARY OF THE INVENTION

Therefore, it is one objective of the invention to provide a single use high-speed turbine dental drill handpiece to overcome the problems of complicated back handle structure, using multiple parts, high manufacturing cost, and time-consuming assembly of the existing high-speed dental drill handpiece.

In order to realize the above objective, provided is a single use high-speed turbine dental drill handpiece, comprising: a head, a drilling needle, a front handle, a back handle, and a quick water and air disconnect adapter, wherein the front end of the back handle is connected with the front handle, the back end of the back handle is connected with the quick water and air disconnect adapter; the back handle has a solid monolithic structure with an inner through channel and is made of engineering plastics formed by single stage moulding; a water pipe passage is set at the axle center position at the front portion of the back handle; a gas pipe passage and an air return passage are set at the eccentric position of the axial direction; the air pipe and the water pipe from the head of the dental drill handpiece are inserted into the above air pipe passage and the water pipe passage, respectively; the clearance space is sealed by a sealing ring; the center of the back end of the back handle is protuberant to form a quick disconnect inner tube having a center channel; the inner end of the center channel of the quick disconnect inner tube is connected with a check valve, the check valve is inserted into the water pipe passage at the front portion of the back handle, and the outer wall of the valve body of the check valve contacting with the inner wall of the water pipe passage is embedded with a sealing ring; and the outlet of the air return passage is located at a position between the outer wall of the back handle and the quick disconnect inner tube.

In a class of this embodiment or in another embodiment, the valve body of the check valve is opened with a water outlet, and the outer wall of the water outlet is tightly hooped with a rubber tube.

In another class of this embodiment or in another embodiment, the symmetrical position of the back handle to the air return passage is set with one or more fabrication holes.

In another class of this embodiment or in another embodiment, the cross section of the air pipe passage is in the shape of a crescent, an ellipse, or a circle.

In another class of this embodiment or in another embodiment, the outer wall of the quick disconnect inner tube is disposed with one or more ring slots, the inner wall of the corresponding quick water and air disconnect adapter tube is embedded with one or more sets of locking balls.

In another class of this embodiment or in another embodiment, the outer wall of the quick disconnect inner tube is disposed with one or more ring slots, the external circle of the quick disconnect inner tube can be in a shape of cone; the inner wall of the corresponding quick water and air disconnect adapter tube is embedded with one or more sets of locking balls.

As a result, the single use high-speed turbine dental drill handpiece of the invention provides the following advantages:
1) The structure of the back handle is monolithically designed and is simple, the original multiplicity of metal or plastic parts used for assembling the entire back handle of the existing high-speed turbine dental drill handpiece is replaced by one monolithically-formed part of the high-speed turbine dental drill handpiece of the present invention, the manufacturing cost is decreased largely, and at the same time, assembly of many parts is avoided so that the manufacturing time is saved, the opportunity of causing malfunction is reduced, the operational reliability is improved, and thus, the product cost is decreased further.
2) The entire back handle is made of engineering plastics formed by single stage moulding, and thus is light and has a good strength performance.
3) A water suckback prevention check valve is disposed in the water inlet passage of the present invention, so that the water suckback contamination due to the water pressure change is avoided effectively. This design simplifies the process for installation and increases the operational reliability.
4) The engagement of the ring slots on the outer wall of the quick disconnect inner tube and the locking balls on the inner wall of the quick water and air disconnect adapter tube conveniences the replacement of the quick water and air disconnect adapter, the assembly is convenient and the assembly time can be reduced significantly. Since the quick disconnect inner tube at the rear portion is made of thin wall plastic material with certain elasticity, the quick water and air disconnect adapter can be inserted directly. It is not needed to pull back the limit ring on the quick water and air disconnect adapter, contributing to the convenience of assembly. The back handle made of normal metal material cannot and does not provide this capability.
5) The structure of the back handle is flexible, and the rear portion of the back handle can be designed into various structures with different dimensions, and thus is suitable for connecting with various quick-disconnect water and air adapters from the dental equipment.

### BRIEF DESCRIPTION OF THE DRAWINGS

The invention is described hereinbelow with reference to accompanying drawings, in which:

FIG. 1 illustrates a structural view of an existing single use high-speed turbine dental drill handpiece;

FIG. 2 illustrates a structural view of a single use high-speed turbine dental drill handpiece in accordance with one embodiment of the invention;

FIG. 3 illustrates a sectional view of another direction of a back handle, namely rotating 90°, in accordance with one embodiment of the invention;

FIG. 4 illustrates a structural view of a back handle along the A direction in accordance with one embodiments of the invention;

FIG. 5 illustrates a structural view of a water suckback prevention check valve wherein the pressure water can pass through in accordance with one embodiment of the invention; and

FIG. 6 illustrates a structural view of a water suckback prevention check valve wherein the pressure water is cut off and the back flow of the contaminated fluid is blocked in accordance with one embodiment of the invention.

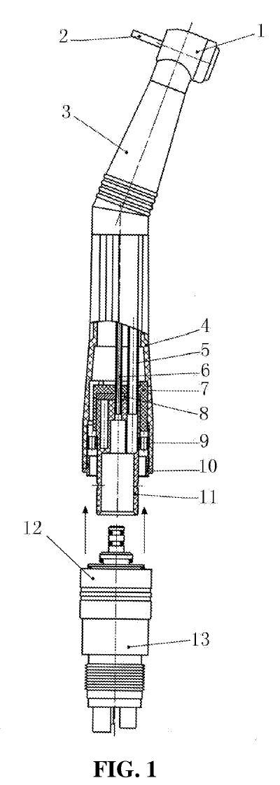

The reference numbers of the various parts shown in above drawings are listed below, in which head body corresponds to the number 1; drilling needle—2; front handle—3; air pipe—5; water pipe—6; positioning sleeve—7; sealing cushion—8; nut—9; toggle—10; connection sleeve—11; protection cover of quick water and air disconnect adapter—12; quick water and air disconnect adapter—13; locking ball—15; O sealing ring for air pipe—16; O sealing ring for water pipe—17; back handle—4, water inlet passage—41; air inlet passage—42; air return passage—43; fabrication holes—44; quick disconnect inner tube—45; outlet of air return passage—46; ring slot—451; external circle of quick disconnect inner tube—452; check valve—14; rubber tube—141; water outlet—142; sealing ring—143; valve body—144.

### BEST MODE OF CARRYING OUT THE INVENTION

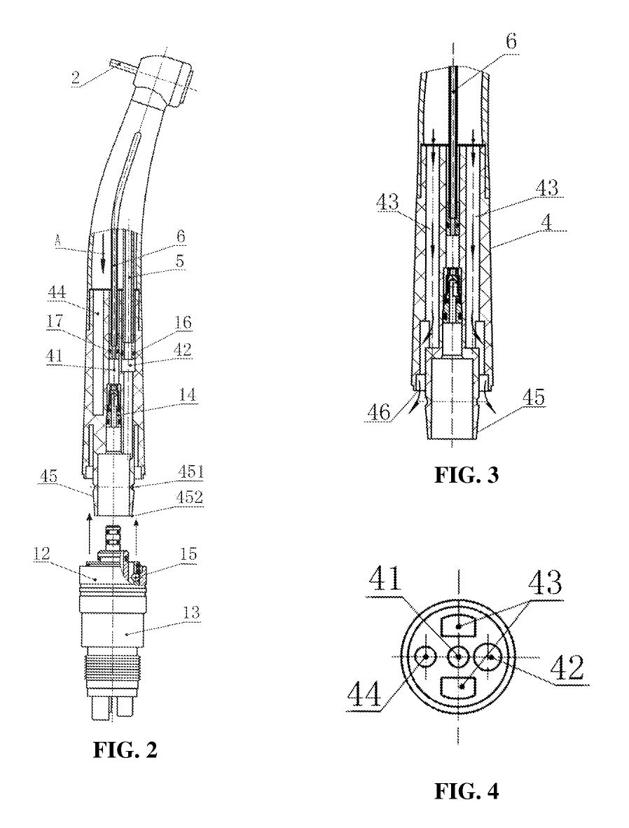

As shown in FIG. 2 and FIG. 4, an air inlet passage 42 and a water inlet passage 41 are set at the front portion of the back handle 4. An air pipe 5 and a water pipe 6 from the head 1 are inserted into the air inlet passage 42 and the water inlet passage 41, respectively. The clearance space between the connections is sealed by O-type air pipe sealing ring and O-type water pipe sealing ring, respectively. A water suckback prevention check valve 14 is set in the water inlet passage 41. The quick disconnect inner tube 45 at the rear portion of the back handle can be designed into various structures with different dimensions, and can be connected with various quick disconnect water and air adapters 13 from the dental equipment.

One end of the back handle is plug connected with the front handle 3 of the handpiece. The other end is connected with the quick disconnect water and air adapter 13 from the dental equipment. When connecting, the protection cover 12 of the quick disconnect water and air adapter can be pulled back so that the three locking balls 15 in the adapter 13 can be inserted/disconnected quickly into the ring slot 451 of the quick disconnect inner tube 45. By loosing the protection cover 12, the quick disconnect water and air adapter can be installed. Since the back handle of the present invention is made of engineering plastics, the top end of the quick disconnect inner tube 45 connected with the quick disconnect water and air adapter 13 is in a structure of thin wall tube, the outer wall of the quick disconnect inner tube 45 is opened with one or more ring slots 451, and the external circle 452 of the quick disconnect inner tube is in a shape of cone, so that the quick disconnect water and air adapter 13 can be inserted into the quick disconnect inner tube 45 without pulling the protection cover 12. Depending on the deformation of the head portion of the quick disconnect inner tube 45 under the action of the three locking balls 15 of the adapter, the locking balls 15 can be entered into the ring slot 451.

As shown in FIG. 3, the turbine return air from the head flows into the two air return passages 43 having a crescent shaped cross section of the back handle from the orifice of the front handle along the arrow direction, and then flows into the corresponding passages of the quick disconnect water and air adapter 13 from the outlet 46 of the air return passage at the rear portion of the back handle, and then discharges into the atmosphere or into the corresponding part of the dental equipment. The outlet 46 of the air return passage is located between the outer wall of the back handle and the quick disconnect inner tube.

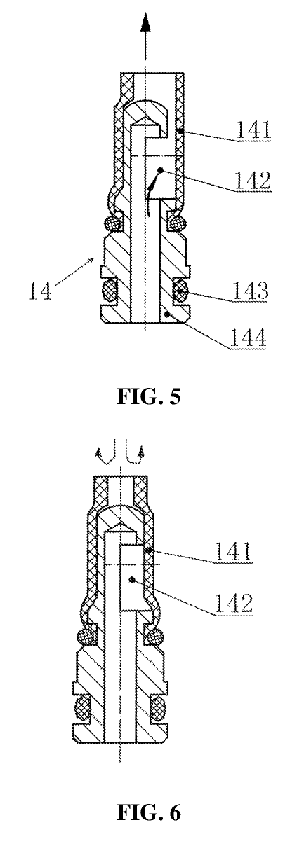

With reference to FIG. 2 and FIG. 5, when the dental drill handpiece is in operation and the drilling needle 2 is rotating, the pressure water from the quick disconnect water and air adapter 13 flows into the check valve 14, pushes the rubber tube 141 open from the water outlet 142 of the valve body, then flows into the water pipe 6, and then sprays out from the head for cooling the drilling needle 2. The check valve is a separate component, is easy to be installed into the water pipe passage, and is easy to be taken out from the water pipe passage. The outer wall of the valve body 144 contacting the water pipe passage is embedded with a sealing ring 143.

With reference to FIG. 2 and FIG. 6, when the dental drill handpiece stops working, it is impossible that the collected contaminated fluid flows back to the water passage under the circumstances of water pressure change. Since the water inlet pressure disappears after the dental drill handpiece stops working, the rubber tube 141 can immediately seal the water outlet 142 of the check valve 14, so that the water suckback phenomenon can be avoided reliably.

The invention claimed is:

1. A single-use high-speed turbine dental drill handpiece, comprising: a head, a drilling needle, a front handle, a back handle, and a quick disconnect water and air adapter, wherein
the front end of the back handle is connected with the front handle, and the back end is connected with the quick disconnect water and air adapter;
said back handle has a solid monolithic structure with an inner through channel and is made of engineering plastics formed by single stage moulding;
a water pipe passage is set at the axle center of the front portion of said back handle, an air pipe passage and an air return passage are set at the eccentric position along the axial direction;
an air pipe and a water pipe from said head are inserted into said air pipe passage and said water pipe passage, respectively, the clearance space is sealed by a sealing ring;
the center of the rear end of said back handle is protuberant to form a quick disconnect inner tube having a center channel;
the inner end of the center channel of said quick disconnect inner tube is connected with a check valve;
said check valve is inserted into said water pipe passage at the front portion of said back handle;
the outer wall of said valve body of said check valve contacting with the inner wall of said water pipe passage is embedded with a sealing ring; and
the outlet of said air return passage is located at a position between the outer wall of said back handle and said quick disconnect inner tube.

2. The dental drill handpiece of claim 1, wherein the valve body of said check valve is opened with a water outlet, and the outer wall of said water outlet is tightly hooped with a rubber tube.

3. The dental drill handpiece of claim 1, wherein the symmetrical position of said back handle to said air return passage is set with one or more fabrication holes.

4. The dental drill handpiece of claim 1, wherein the cross section of said air pipe passage is in the shape of a crescent, an ellipse, or a circle.

5. The dental drill handpiece of claim 1, wherein the outer wall of said quick disconnect inner tube is disposed with one or more ring slots, the inner wall of said corresponding quick water and air disconnect adapter tube is embedded with one or more sets of locking balls.

6. The dental drill handpiece of claim 1, wherein the outer wall of said quick disconnect inner tube is disposed with one or more ring slots, the external circle of said quick disconnect inner tube can be in a shape of cone, and the inner wall of said corresponding quick water and air disconnect adapter tube is embedded with one or more sets of locking balls.

7. The dental drill handpiece of claim 2, wherein the symmetrical position of said back handle to said air return passage is set with one or more fabrication holes.

8. The dental drill handpiece of claim 2, wherein the cross section of said air pipe passage is in the shape of a crescent, an ellipse, or a circle.

9. The dental drill handpiece of claim 2, wherein the outer wall of said quick disconnect inner tube is disposed with one or more ring slots, the inner wall of said corresponding quick water and air disconnect adapter tube is embedded with one or more sets of locking balls.

10. The dental drill handpiece of claim 2, wherein the outer wall of said quick disconnect inner tube is disposed with one or more ring slots, the external circle of said quick disconnect inner tube can be in a shape of cone, and the inner wall of said corresponding quick water and air disconnect adapter tube is embedded with one or more sets of locking balls.
